(19) United States
(12) Patent Application Publication
(10) Pub. No.: US 2014/0118832 A1
(43) Pub. Date: May 1, 2014

(54) TOUCHSCREEN PANEL

(71) Applicant: SAMSUNG ELECTRO-MECHANICS CO., LTD., Suwon (KR)

(72) Inventors: Jae Hyoung Gil, Suwon (KR); Kyoung Jin Jeong, Suwon (KR); Kee Su Jeon, Suwon (KR); Tae Hoon Kim, Suwon (KR)

(73) Assignee: Samsung Electro-Mechanics Co., Ltd., Suwon (KR)

(21) Appl. No.: 13/721,469

(22) Filed: Dec. 20, 2012

(30) Foreign Application Priority Data
Oct. 29, 2012 (KR) 10-2012-0120732

(51) Int. Cl. G02B 5/02

(52) U.S. Cl. CPC G02B 5/0284
USPC 359/599; 428/141

(57) ABSTRACT

There is provided a touchscreen panel, including: a transparent substrate including a first area having a first surface roughness and a second area having a second surface roughness; and an ink layer formed on the second area, wherein the degree of second surface roughness is higher than the degree of first surface roughness.

### CROSS-REFERENCE TO RELATED APPLICATIONS

This application claims the priority of Korean Patent Application No. 10-2012-0120732 filed on Oct. 29, 2012, in the Korean Intellectual Property Office, the disclosure of which is incorporated herein by reference.

### BACKGROUND OF THE INVENTION

1. Field of the Invention

The present invention relates to a touchscreen panel, and more particularly, to a touchscreen panel provided in a portable terminal.

2. Description of the Related Art

As smart phones and tablet PCs have been commercialized, technological development of touchscreen panels has been continuously conducted. For example, a touchscreen module (TSM) has been rapidly changed from resistive type touchscreens to capacitive type touchscreens. As another example, the structure of capacitive type touchscreens has also been changed from types thereof such as GFF, GF2, and the like, to a window integrated TSM or an on-cell or an in-cell type TSM.

Meanwhile, in the window integrated TSM, a bezel is coated with ink and then, is coated with sensor electrodes. However, the sensor electrodes are very slim, such that fractures thereof at corners of the bezel may occur.

In order to resolve this problem, the bezel needs to have a maximally reduced thickness. However, sensor electrodes on a rear surface of the bezel may be seen through a front surface thereof since ink (for example, white ink) having high brightness allows light to be easily transmitted therethrough. Therefore, regardless of the brightness of ink, a need exists for the development of a bezel having a significantly reduced thickness.

Meanwhile, there is Patent Document 1 as the related art associated with the touchscreen panel. Patent Document 1 discloses a technology of forming a black color layer by thin film deposition. However, Patent Document 1 merely discloses a technology of making color layers thin, such that it is difficult to form color layers (for example, a white layer) having good light transmittance on a touch panel glass 10.

### RELATED ART DOCUMENT

(Patent Document 1) KR 2011-053940 A

### SUMMARY OF THE INVENTION

An aspect of the present invention provides a touchscreen panel with a bezel preventing light from being transmitted therethrough while having a reduced thickness.

According to an aspect of the present invention, there is provided a touchscreen panel, including: a transparent substrate including a first area having a first surface roughness and a second area having a second surface roughness; and an ink layer formed on the second area, wherein the degree of second surface roughness is higher than the degree of first surface roughness.

The ink layer may be formed of ink having a high degree of brightness.

The ink layer may be formed of white ink.

The ink layer may have a thickness of 10 μm or less.

The second area may be a groove formed by grinding an edge of the transparent substrate.

The groove may have a depth of 10 μm, and an upper surface of the ink layer and an upper surface of the transparent substrate may be on the same plane.

The second area may be a groove formed by etching an edge of the transparent substrate.

The groove may have a depth of 10 μm, and an upper surface of the ink layer and an upper surface of the transparent substrate may be on the same plane.

The touchscreen panel may further include sensor electrodes formed on the ink layer and the transparent substrate.

According to another aspect of the present invention, there is provided a touchscreen panel, including: a transparent substrate; a scattering layer attached to the transparent substrate and having a degree of surface roughness different from that of the transparent substrate; and an ink layer formed on the scattering layer.

The scattering layer may be formed of an adhesive material adhered to an edge of the transparent substrate.

The ink layer may be formed of ink having a high degree of brightness.

The ink layer may be formed of white ink.

The ink layer may have a thickness of 10 μm or less.

The touchscreen panel may further include sensor electrodes formed on the ink layer and the transparent substrate.

According to another aspect of the present invention, there is provided a touchscreen panel, including: a transparent substrate having a groove formed in an edge thereof; an ink layer formed in the groove; and particles included in the ink layer to cause diffuse reflection of light.

The ink layer may be formed of ink having a high degree of brightness.

The ink layer may be formed of white ink.

The ink layer may have a thickness of 10 μm or less.

The touchscreen panel may further include sensor electrodes formed on the ink layer and the transparent substrate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a touchscreen panel according to a first embodiment of the present invention;

FIG. 2 is an enlarged view of portion A illustrated in FIG. 1;

FIG. 3 is a diagram illustrating a process of manufacturing the touchscreen panel illustrated in FIG. 1;

FIG. 4 is a cross-sectional view of a touchscreen panel according to a second embodiment of the present invention;

FIG. 5 is a cross-sectional view of a touchscreen panel according to a third embodiment of the present invention;

FIG. 6 is a diagram illustrating a process of manufacturing the touchscreen panel illustrated in FIG. 5;

FIG. 7 is a cross-sectional view of a touchscreen panel according to a fourth embodiment of the present invention;

FIG. 8 is an enlarged view of portion B illustrated in FIG. 7;

FIG. 9 is a cross-sectional view of a touchscreen panel according to a fifth embodiment of the present invention; and

FIG. 10 is an enlarged view of portion C illustrated in FIG. 9.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

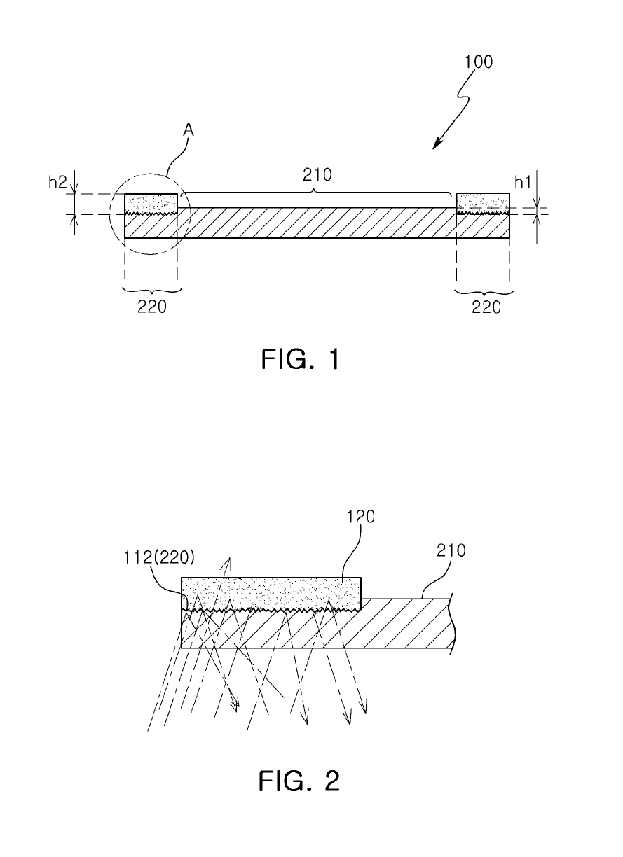

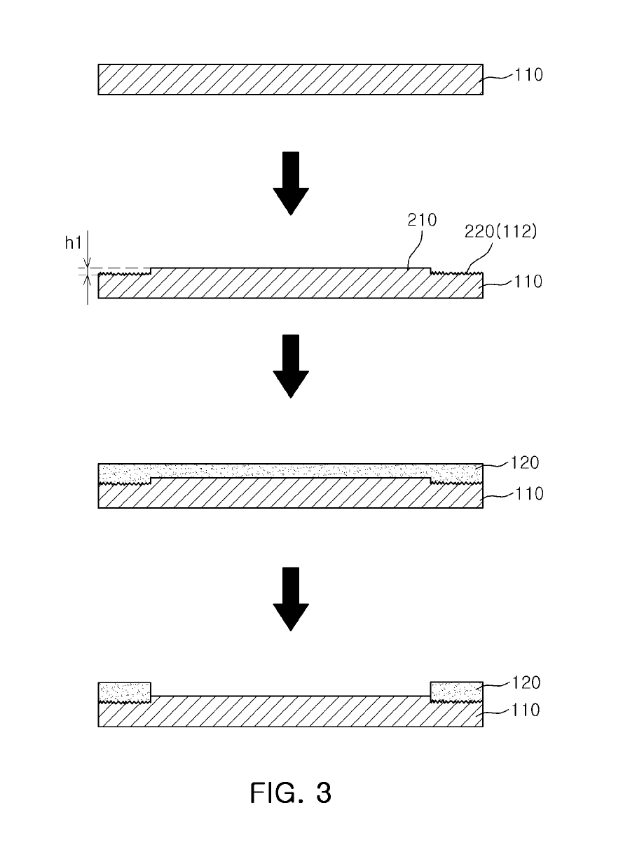

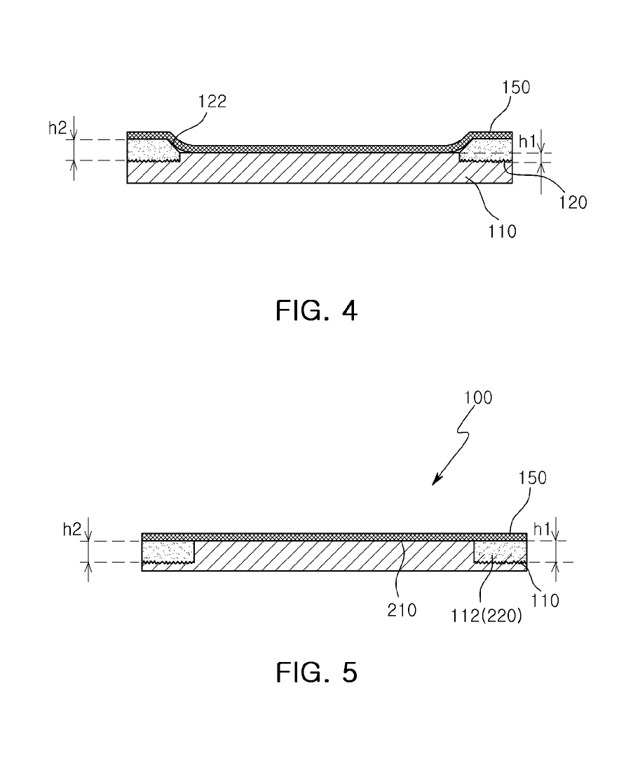

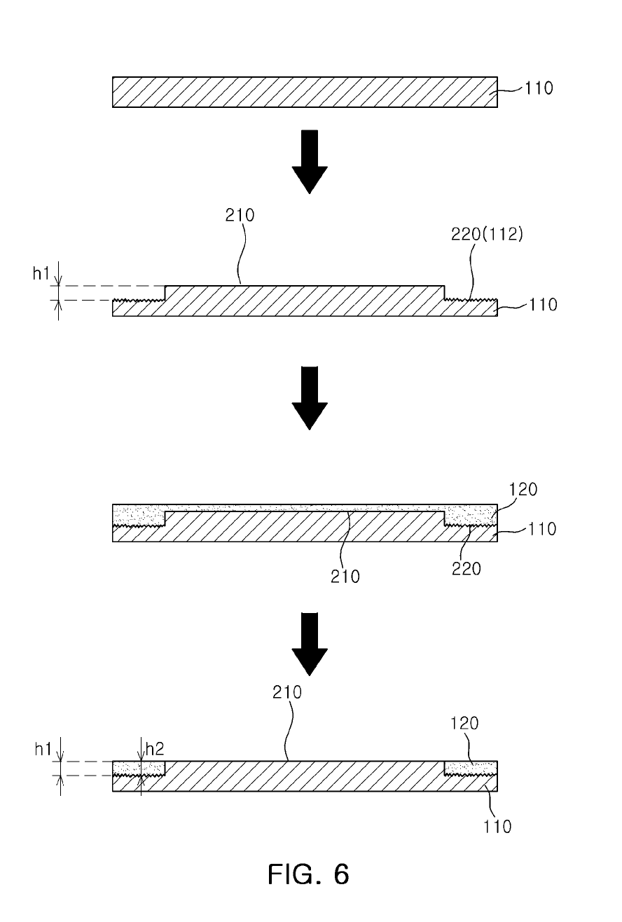

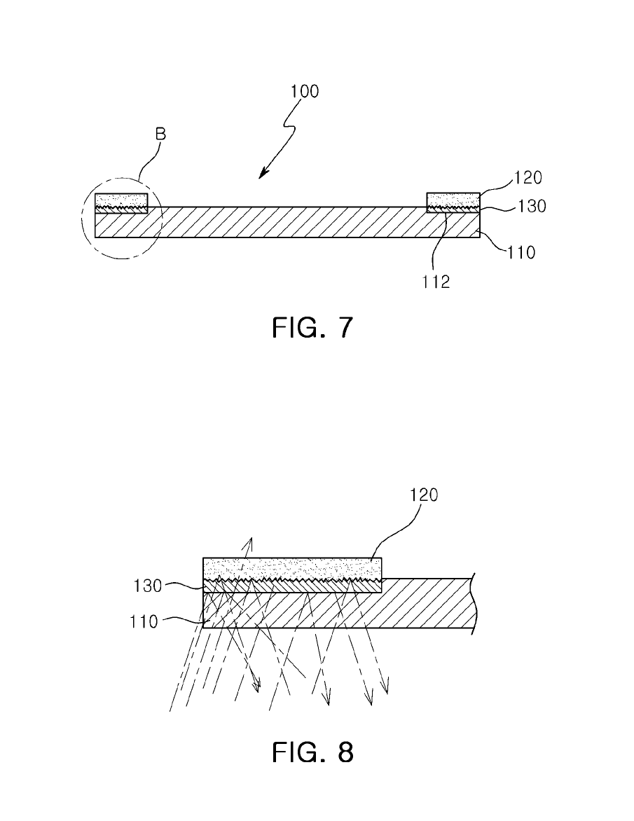

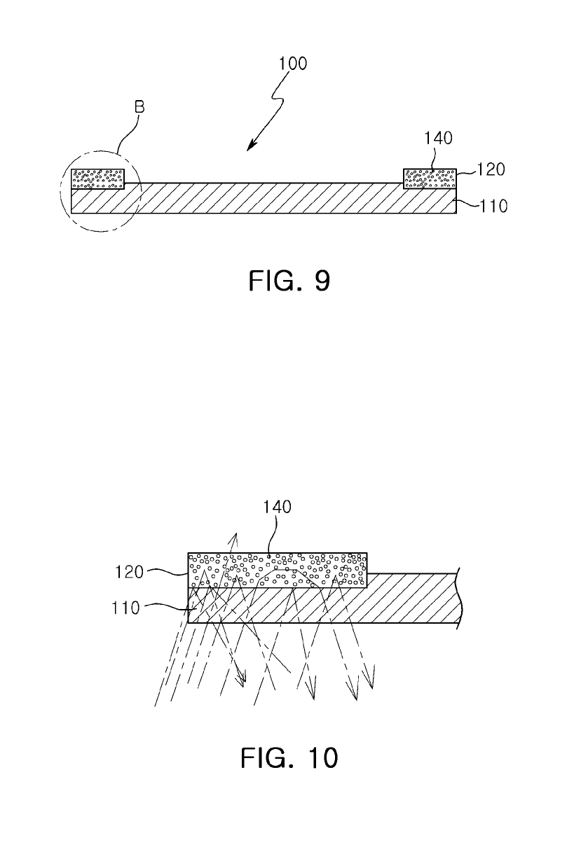

FIG. 1 is a cross-sectional view of a touchscreen panel according to a first embodiment of the present invention, FIG. 2 is an enlarged view of portion A illustrated in FIG. 1, FIG. 3 is a diagram illustrating a process of manufacturing the touchscreen panel illustrated in FIG. 1, FIG. 4 is a cross-sectional view of a touchscreen panel according to a second embodiment of the present invention, FIG. 5 is a cross-sectional view of a touchscreen panel according to a third embodiment of the present invention, FIG. 6 is a diagram illustrating a process of manufacturing the touchscreen panel illustrated in FIG. 5, FIG. 7 is a cross-sectional view of a touchscreen panel according to a fourth embodiment of the present invention, FIG. 8 is an enlarged view of portion B illustrated in FIG. 7, FIG. 9 is a cross-sectional view of a touchscreen panel according to a fifth embodiment of the present invention, and FIG. 10 is an enlarged view of portion C illustrated in FIG. 9.

A touchscreen panel according to a first embodiment of the present invention will be described with reference to FIGS. 1 to 3.

A touchscreen panel 100 according to the first embodiment of the present invention may include a transparent substrate 110 and an ink layer 120. Further, the touchscreen panel 100 may further include sensor electrodes (not shown).

The transparent substrate 110 may be formed of glass or plastic. Specifically, the transparent substrate 100 is formed of a tempered glass material having high impact resistance or a synthetic resin such as poly (methyl methacrylate) (PMMA) having excellent light transmittance.

Both surfaces of the transparent substrate 110 may be processed so as to allow light to transmit therethrough well. For example, both surfaces of the transparent substrate 110 may be processed by a fine abrasive material. The transparent substrate 110, subjected to abrasive blasting, may be cleaned by a separate cleaning process.

Meanwhile, one surface of the transparent substrate 110 may be provided with areas having different degrees of surface roughness. Specifically, one surface of the transparent substrate 110 may be partitioned into a first area 210 having a first surface roughness and a second area 220 having a second surface roughness.

The first area 210 may be formed in a center of the transparent substrate 110. Specifically, the first area 210 may be formed in an area of the touchscreen panel 100 in which an execution screen is substantially projected. Therefore, the first area 210 may have a very low degree of first surface roughness so that the execution screen may be sharply seen to a user. For example, a first roughness may have the same degree of surface roughness as a smooth glass surface.

The second area 220 may be formed on an edge of the transparent substrate 110. Specifically, the second area 220 may be formed in an area of the touchscreen panel 100 in which the execution screen is not projected. Therefore, the second area may have the second surface roughness having a degree of surface roughness higher than that of the first area 210. Here, the second surface roughness may be higher than 0.01 μm or lower than 1.0 μm.

The second area 220 may have a high degree of second surface roughness by chemical machining or mechanical machining. For example, the second area 220 may be obtained by etching a portion of the transparent substrate 110. Alternatively, the second area 220 may be obtained by grinding a portion of the transparent substrate 110 with a grinder. For reference, the second area 220 according to the first embodiment of the present invention may be obtained by etching a portion of the transparent substrate 110.

The second area 220 may be formed to be lower than the first area 210. Specifically, the second area 220 may have the form of a groove 112 as illustrated in FIG. 2. Here, the groove 112 may have a predetermined depth h1. Here, the depth h1 may be set to be 10 μm or less.

As such, the second area 220 having the second surface roughness may refract or scatter light as illustrated in FIG. 2. Therefore, due to these characteristics, the electrode sensors or other wirings disposed in the second area 220 may not be easily seen from the other surface of the transparent substrate 110.

The ink layer 120 may be formed on the second area 220. Specifically, the ink layer 120 may be formed to have a predetermined height h2 in the groove 112 of the transparent substrate 110 that is the second area 220. Here, the height h2 of the ink layer 120 may be 10 ∞m or less. That is, the height h2 may be set to allow damage (for example, fractures) to the sensor electrodes to be minimized and allow the overall thickness of the touchscreen panel 100 to be minimized.

Meanwhile, the height h2 of the ink layer 120 may be in proportion to the depth h1 of the groove 112. For example, when the depth h1 of the groove 112 is increased, the height h2 of the ink layer 120 may be increased, and when the depth h1 of the groove 112 is reduced, the height h2 of the ink layer 120 may be reduced. However, a change in the height h2 of the ink layer 120 may be made within a range allowing damage to the sensor electrodes to be significantly reduced.

The ink layer 120 may be formed of ink having a predetermined color. For example, the ink layer 120 may be formed of any one of white, yellow, blue, and black inks.

The ink layer 120 may be made of photosensitive ink and may be formed by spin coating or slit coating. However, a method of forming the ink layer 120 is not limited to the foregoing methods and, the ink layer 120 may be formed by other various methods.

In the touchscreen panel 100 configured as described above, the diffuse reflection of light occurs in the second area 220 in which the ink layer 120 are formed, such that the color of the ink layer 120 may be relatively sharp when viewed. That is, in the touchscreen panel 100, the sensor electrodes formed on the ink layer 120 may not be seen very well on one surface of the transparent substrate 110 due to the diffuse reflection phenomenon of the second area 220. Therefore, in the touchscreen panel 100, the ink layer 120 may be formed to be thinner than in the related art, such that damage to the sensor electrodes may be reduced.

The above effect may be confirmed by the experimentation of the inventors. Table 1 shows experimental results of an example in which the ink layer 120 is formed of white ink. For reference, in Table 1, percentages corresponding to respective experiments represent the implementation of the color of the ink layer. Therefore, it could be appreciated that as the percentages approach 100%, the color of the ink layer are distinctly shown.

TABLE 1

| | | Experiment | Experiment | Thickness of |
|---|---|---|---|---|
| | Experiment 1 | 2 | 3 | Ink Layer |
| Related Art | 67.73% | 67.87% | 67.17% | 4 |
| Invention | | | | |
| Present | 84.45% | 83.08% | 84.20% | 2.5 |
| Invention | | | | |

As can be appreciated from Table 1, the touchscreen panel 100 according to the first embodiment of the present invention shows percentage figures of 83% or above while having a relatively small thickness (2.5 μm) of the ink layer. Therefore, even in the case in which the ink layer on the touchscreen panel 100 has a thickness of 2.5 to 10 μm, the color of the ink layer may be sharply implemented.

Unlike this, the related art invention shows percentage figures of 68% or below while having a relatively great thickness (4 μm) of the ink layer, such that the thickness of the ink layer needs to be formed to be 20 to 60 μm so as to sharply implement the color therein.

As described above, in the touchscreen panel 100, the thickness of the ink layer 120 may be 10 μm or less due to the second area having the surface roughness different from that of the first area, and damage to the sensor electrodes may be significantly reduced due to a difference in a height between the ink layer 120 and the transparent substrate 110. Further, the overall thickness of the touchscreen panel 100 may be reduced by an amount equal to the thinness of the ink layer 120.

Next, a process of manufacturing the touchscreen panel 100 will be described with reference to FIG. 3.

The process of manufacturing the touchscreen panel 100 may include preparing a transparent substrate, forming a second area, forming an ink layer, and processing the ink layer.

1) Preparing Transparent Substrate

The object of the present process may be the preparing of the transparent substrate 110. Specifically, the present process may include cutting the transparent substrate 110 to fit a size of the touchscreen panel. Further, the present process may include making both surfaces of the transparent substrate 110 smooth.

2) Forming Second Area

The present process may include forming the first area 210 and the second area 220 on the transparent substrate 110. Specifically, the present process may include forming the second area 220 by processing a portion of the transparent substrate 110. For example, in the present process, the second area 220 having the second surface roughness may be formed by etching or grinding a portion of the first area 210 having the first surface roughness. Meanwhile, the second area 220 formed by etching or grinding is formed to be lower than the first area 210 and thus, may have a predetermined depth h1.

3) Forming Ink Layer

The present process may be the forming of the ink layer 120 on one surface of the transparent substrate 110. The ink layer 120 may be formed by spin coating or slit coating. However, the method of forming the ink layer 120 is not limited to the foregoing methods and therefore, the ink layer 120 may be formed by other various methods.

4) Processing Ink Layer

The present process may be the processing of the ink layer 120. Specifically, the ink layer 120 formed on the first area 220 may be removed. The ink layer 120 may be removed by photoresist and developing. That is, a mask pattern may be attached to the ink layer 120 of the first area 210 and only the ink layer 120 of the second area 220 may be exposed, such that the ink layer 120 of the first area 210 may be removed by a developer.

Next, touchscreen panels according to other embodiments of the present invention will be described. For reference, in the embodiments to be described below, the same components as those of the first embodiment are denoted by reference numerals used in the first embodiment, and therefore, detailed descriptions thereof will be omitted.

A touchscreen panel according to a second embodiment of the present invention will be described with reference to FIG. 4.

The touchscreen panel 100 according to the second embodiment of the present invention may be differentiated from the first embodiment of present invention in terms of the shape of the ink layer 120. Specifically, the ink layer 120 according to the second embodiment of the present invention may be provided with an inclined surface 122. Here, the degree of inclination of the inclined surface 122 may be determined to significantly reduce damage (for example, fracture phenomenon) to sensor electrodes 150. Meanwhile, FIG. 4 illustrates that the inclined surface 122 of the ink layer 120 may have a straight shape, but the inclined surface of the ink layer 120 may have a curved shape as needed.

In the touchscreen panel 100 configured as described above, the sensor electrodes 150 are formed to have a smooth curved shape on an upper surface (based on FIG. 4) of the ink layer 120 and an upper surface of the transparent substrate 110, such that damage to the sensor electrodes 150 may be significantly reduced at a boundary between the ink layer 120 and the transparent substrate 110.

Next, a touchscreen panel according to a third embodiment of the present invention will be described with reference to FIGS. 5 and 6.

The third embodiment of the present invention may be differentiated from the foregoing embodiments in that the ink layer 120 and one surface of the transparent substrate 110 are on the same plane. For this purpose, the depth h1 of the groove 112 may be equal to the height h2 of the ink layer 120. Here, the depth h1 may be set to be 10 μm or less.

Meanwhile, the touchscreen panel 100 according to the third embodiment of the present invention may be manufactured by the preparing of the transparent substrate, the forming of the second area, the forming of the ink layer, and the processing of the ink layer, as illustrated in FIG. 6. Here, the preparing of the transparent substrate, the forming of the second area, and the forming of the ink layer are the same as the processes of manufacturing the touchscreen panel 100 according to the first embodiment of the present invention and therefore, detailed descriptions thereof will be omitted.

The processing of the ink layer may further include grinding. Specifically, the processing of the ink layer may further include grinding the ink layer 120 formed on the transparent substrate 110 so as to expose the transparent substrate 110.

Alternatively, the processing of the ink layer may be performed by removing the ink layer 120 formed on the first area 210 by photoresist and developing processes and then, removing the ink layer 120 formed on the second area 220 by a grinding process.

In the touchscreen panel 100 configured as described above, the upper surface of the ink layer 120 and the upper surface of the transparent substrate 110 are on the same plane, such that the attachment of the sensor electrodes 150 may be facilitated and damage to the sensor electrodes 150 may be significantly reduced.

Next, a touchscreen panel according to a fourth embodiment of the present invention will be described with reference to FIGS. 7 and 8.

The touchscreen panel 100 according to the fourth embodiment of the present invention may be differentiated from the foregoing embodiments of present invention in that the touchscreen panel 100 further includes a scattering layer 130.

The scattering layer 130 may be formed on a portion of the transparent substrate 110. Specifically, the scattering layer 130 may be formed on an edge of the transparent substrate 110. The scattering layer 130 may be formed of a transparent material like the ink layer 120 and may allow incident light to be scattered and diffuse reflected. For this purpose, at least one surface of the scattering layer 130 may be roughly processed. The roughly processed surface may be formed by an etching or grinding process. Alternatively, the scattering layer 130 may be formed of an adhesive material having predetermined particles included therein. In this case, the scattering layer 130 may attach the ink layer 120 to the transparent substrate 110 and may allow light to be scattered and diffuse reflected using the particles included in the adhesive material. Here, the surface roughness of the scattering layer 130 may be higher than 0.01 μm or lower than 1.0 μm.

The ink layer 120 may be formed on the scattering layer 130. Here, the thickness of the ink layer 120 and the scattering layer 130 may be set to be 10 μm or less.

In the touchscreen panel 100 configured as described above, the scattering and diffuse reflection of light are made by the separate scattering layer 130, such that there is no need to divide the upper surface of the transparent substrate 110 into the first area and the second area.

Next, a touchscreen panel according to a fifth embodiment of the present invention will be described with reference to FIGS. 9 and 10.

The touchscreen panel 100 according to the fifth embodiment of the present invention may be differentiated from the foregoing embodiments of present invention in terms of the configuration of the ink layer 120.

The ink layer 120 according to the fifth embodiment of the present invention may include particles 140. For example, the ink layer 120 may be formed of ink including the particles 140. Here, the particles 140 may have a size of 0.1 μm or less, and may allow light incident through the transparent substrate 110 to be scattered or diffuse-reflected.

In the touchscreen panel 100 configured as described above, the scattering and diffuse reflection of light may be made by the particles 140 of the ink layer 120, such that there is no need to process the transparent substrate 110 or attach the separate scattering layer 130 on the transparent substrate 110. Therefore, according to this embodiment, the touchscreen panel 100 may be easily manufactured.

As set forth above, according to the embodiments of the present invention, the thickness of the ink layer can be minimized, such that the fracture phenomenon of the sensor electrodes can be reduced.

While the present invention has been shown and described in connection with the embodiments, it will be apparent to those skilled in the art that modifications and variations can be made without departing from the spirit and scope of the invention as defined by the appended claims.

What is claimed is:

1. A touchscreen panel, comprising:
a transparent substrate including a first area having a first surface roughness and a second area having a second surface roughness; and
an ink layer formed on the second area,
wherein the degree of second surface roughness is higher than the degree of first surface roughness.

2. The touchscreen panel of claim 1, wherein the ink layer is formed of ink having a high degree of brightness.

3. The touchscreen panel of claim 1, wherein the ink layer is formed of white ink.

4. The touchscreen panel of claim 1, wherein the ink layer has a thickness of 10 μm or less.

5. The touchscreen panel of claim 1, wherein the second area is a groove formed by grinding an edge of the transparent substrate.

6. The touchscreen panel of claim 5, wherein the groove has a depth of 10 μm.

7. The touchscreen panel of claim 5, wherein an upper surface of the ink layer and an upper surface of the transparent substrate are on the same plane.

8. The touchscreen panel of claim 1, wherein the second area is a groove formed by etching an edge of the transparent substrate.

9. The touchscreen panel of claim 8, wherein the groove has a depth of 10 μm.

10. The touchscreen panel of claim 8, wherein an upper surface of the ink layer and an upper surface of the transparent substrate are on the same plane.

11. The touchscreen panel of claim 1, further comprising sensor electrodes formed on the ink layer and the transparent substrate.

12. The touchscreen panel of claim 1, wherein the second surface roughness meets the following Condition Equation 1:
(Condition Equation 1) 0.01 μm<the second surface roughness<1.0 μm

13. A touchscreen panel, comprising:
a transparent substrate;
a scattering layer attached to the transparent substrate and having a degree of surface roughness different from that of the transparent substrate; and
an ink layer formed on the scattering layer.

14. The touchscreen panel of claim 13, wherein the scattering layer is formed of an adhesive material adhered to an edge of the transparent substrate.

15. The touchscreen panel of claim 13, wherein the ink layer is formed of ink having a high degree of brightness.

16. The touchscreen panel of claim 13, wherein the ink layer is formed of white ink.

17. The touchscreen panel of claim 13, wherein the ink layer has a thickness of 10 μm or less.

18. The touchscreen panel of claim 13, further comprising sensor electrodes formed on the ink layer and the transparent substrate.

19. The touchscreen panel of claim 13, wherein the surface roughness of the scattering layer meets the following Condition Equation 2:
(Condition Equation 2) 0.01 μm<the surface roughness of the scattering layer<1.0 μm

20. A touchscreen panel, comprising:
a transparent substrate having a groove formed in an edge thereof;
an ink layer formed in the groove; and
particles included in the ink layer to cause diffuse reflection of light.

21. The touchscreen panel of claim 20, wherein the ink layer is formed of ink having a high degree of brightness.

22. The touchscreen panel of claim 20, wherein the ink layer is formed of white ink.

23. The touchscreen panel of claim 20, wherein the ink layer has a thickness of 10 μm or less.

24. The touchscreen panel of claim 20, further comprising sensor electrodes formed on the ink layer and the transparent substrate.
